(19) United States
(12) Patent Application Publication
(10) Pub. No.: US 2016/0365912 A1
(43) Pub. Date: Dec. 15, 2016

(54) CHANNEL STATE REPORTING DURING TUNE AWAY IN MULTI-SUBSCRIBER IDENTITY MODULE DEVICE

(71) Applicant: QUALCOMM Incorporated, San Diego, CA (US)

(72) Inventors: Ming YANG, San Diego, CA (US); Tom CHIN, San Diego, CA (US); Shaohong QU, San Diego, CA (US)

(21) Appl. No.: 14/735,056

(22) Filed: Jun. 9, 2015

(51) Int. Cl. H04B 7/06; H04W 8/18

(52) U.S. Cl. CPC H04B 7/0626; H04W 8/183

(57) ABSTRACT

Decoding failure and throughput loss are reduced when a user equipment (UE) tunes away from a first radio access technology (RAT) to a second radio access technology. In one instance, the UE determines when one or more receive chains will tune away from a first subscriber identity module (SIM) to another SIM. The UE reports a channel state based on measurements obtained without the one or more receive chains during the determined tune away and/or during a predetermined time period before the determined tune away. The UE also reports the channel state based on measurements obtained with the one or more receive chains after the one or more receive chains return from the determined tune away.

### BACKGROUND

Field

Aspects of the present disclosure relate generally to wireless communication systems, and more particularly, to channel state information reporting before, during and after tuning away from a first radio access technology to a second radio access technology of a multi-subscriber identity module device.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method for wireless communication includes determining when at least one receive chain will tune away from a first subscriber identity modules (SIM) to another SIM. The method also includes reporting a channel state based at least in part on measurements obtained without the at least one receive chain during a predetermined time period before the determined tune away. The method also includes reporting the channel state based at least in part on measurements obtained without the at least one receive chain during the determined tune away. The method further includes reporting the channel state based at least in part on measurements obtained with the at least one receive chain after the at least one receive chain returns from the determined tune away.

According to another aspect of the present disclosure, an apparatus for wireless communication includes means for determining when at least one receive chain will tune away from a first SIM to another SIM. The apparatus may also include means for reporting a channel state based at least in part on measurements obtained without the at least one receive chain during a predetermined time period before the determined tune away. The apparatus may also include means for reporting the channel state based at least in part on measurements obtained without the at least one receive chain during the determined tune away. The apparatus further includes means for reporting the channel state based at least in part on measurements obtained with the at least one receive chain after the at least one receive chain returns from the determined tune away.

Another aspect discloses an apparatus for wireless communication and includes a memory and at least one processor coupled to the memory. The processor(s) is configured to determine when at least one receive chain will tune away from a first SIM to another SIM. The processor(s) is also configured to report a channel state based at least in part on measurements obtained without the at least one receive chain during a predetermined time period before the determined tune away. The processor(s) is also configured to report the channel state based at least in part on measurements obtained without the at least one receive chain during the determined tune away. The processor(s) is further configured to report the channel state based at least in part on measurements obtained with the at least one receive chain after the at least one receive chain returns from the determined tune away.

Yet another aspect discloses a computer program product for wireless communications in a wireless network having a non-transitory computer-readable medium. The computer-readable medium has non-transitory program code recorded thereon which, when executed by the processor(s), causes the processor(s) to determine when at least one receive chain will tune away from a first SIM to another SIM. The program code also causes the processor(s) to report a channel state based at least in part on measurements obtained without the at least one receive chain during a predetermined time period before the determined tune away. The program code also causes the processor(s) to report the channel state based at least in part on measurements obtained without the at least one receive chain during the determined tune away. The program code further causes the processor(s) to report the channel state based at least in part on measurements obtained with the at least one receive chain after the at least one receive chain returns from the determined tune away.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a telecommunications system.

FIG. 5 is a block diagram conceptually illustrating an example of a frame structure in a telecommunications system.

FIG. 6 is a block diagram illustrating an example of a Global System for Mobile Communications (GSM) frame structure.

FIG. 7 is a block diagram conceptually illustrating an example of a base station in communication with a user equipment (UE) in a telecommunications system.

FIG. 8 is a diagram illustrating network coverage areas according to aspects of the present disclosure.

FIG. 9 illustrates an example of a call flow diagram for a tune away method for the user equipment with multiple radio frequency receive chains and multiple subscriber identity modules (SIMs) in a wireless network according to aspects of the present disclosure.

FIG. 10 illustrates a communication resource allocation time line for tuning away with one or more receive chains according to aspects of the present disclosure.

FIG. 11 is a flow diagram illustrating a method for tuning away according to one aspect of the present disclosure.

FIG. 12 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

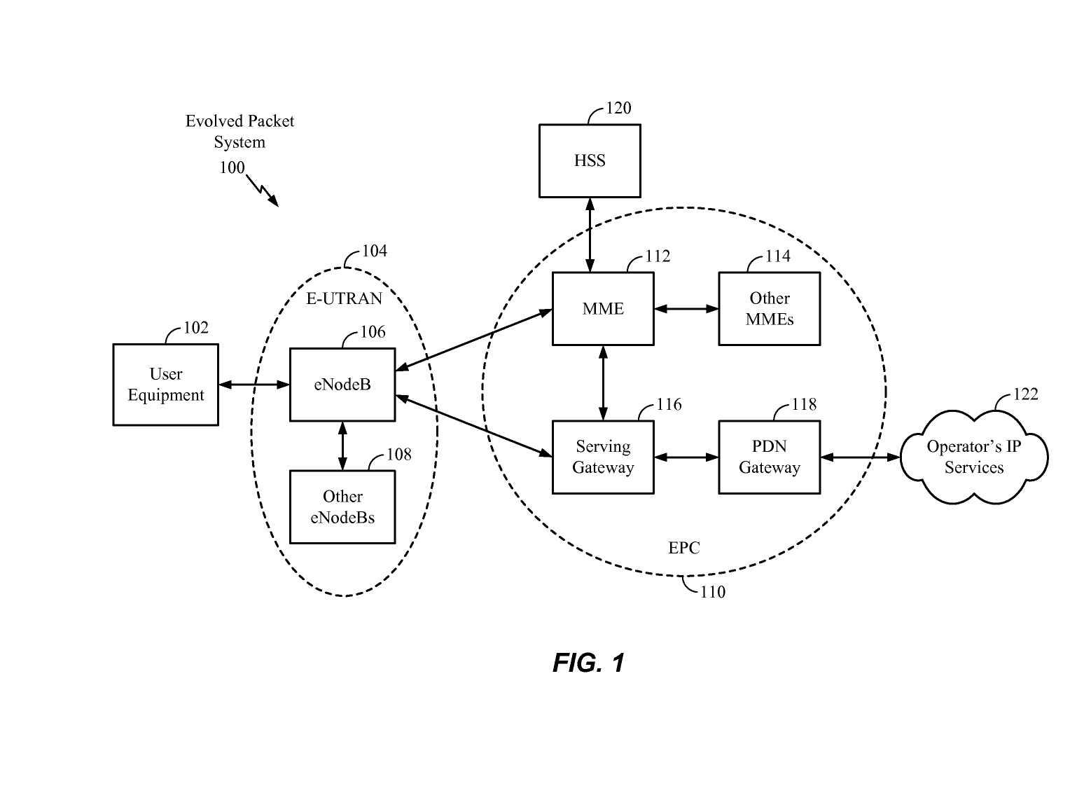

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

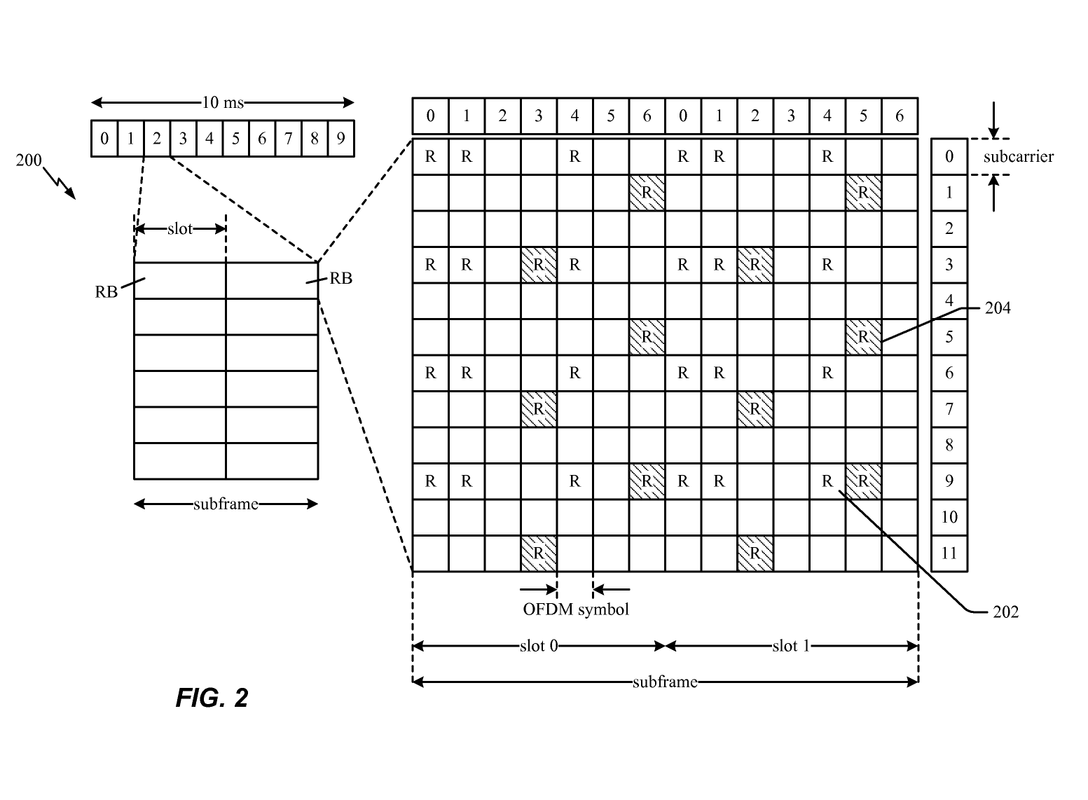

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

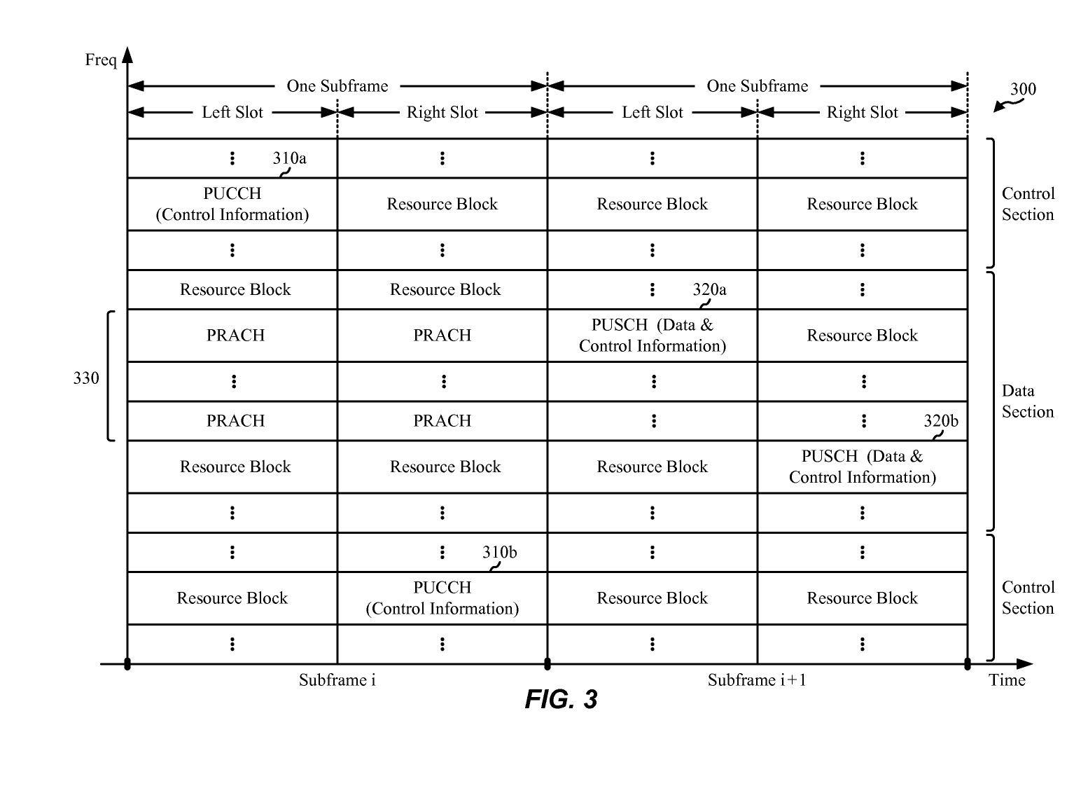

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

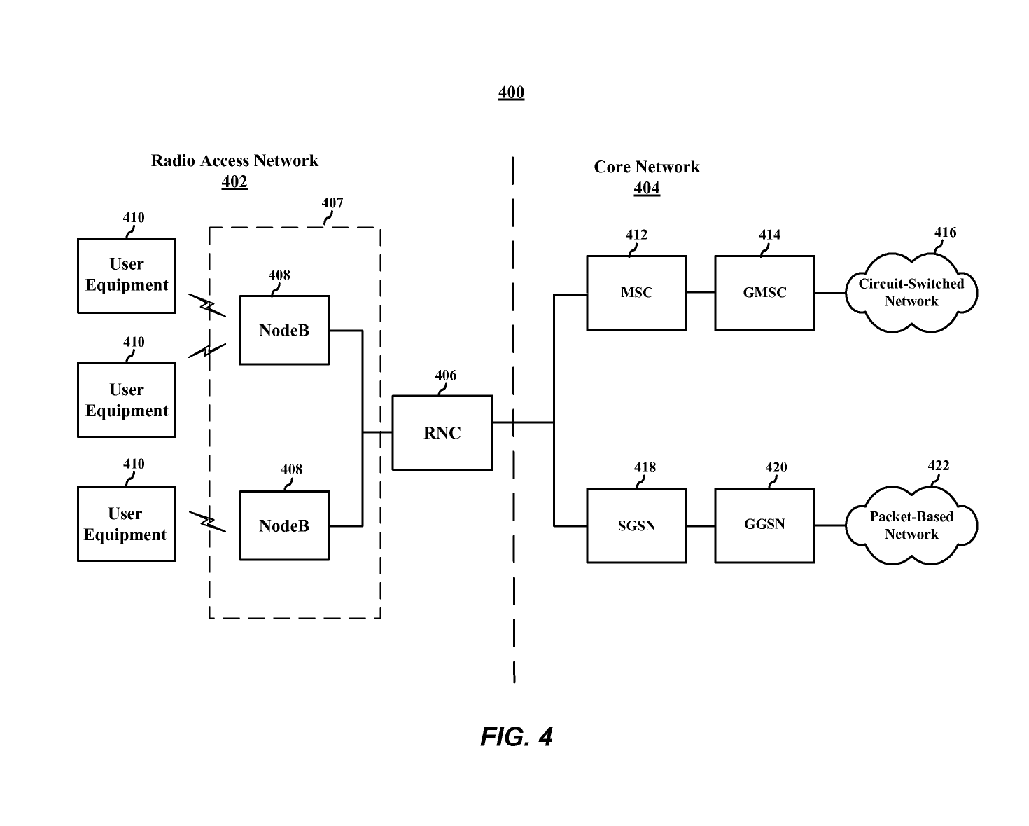

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a (radio access network) RAN 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

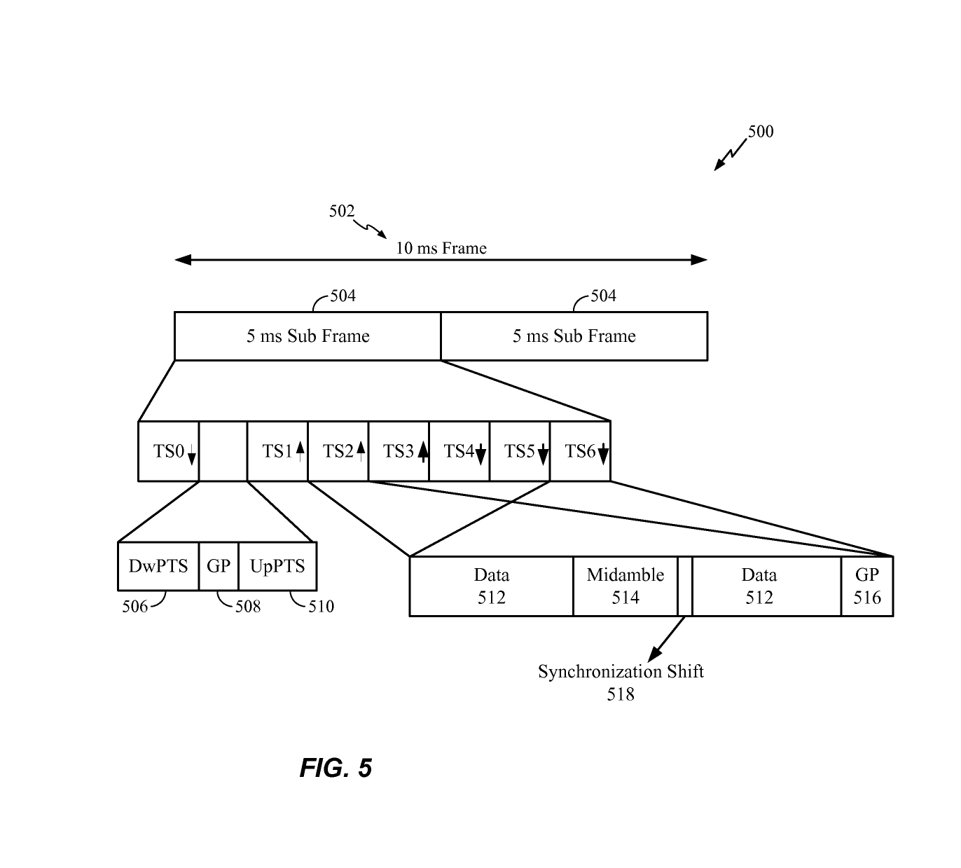

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

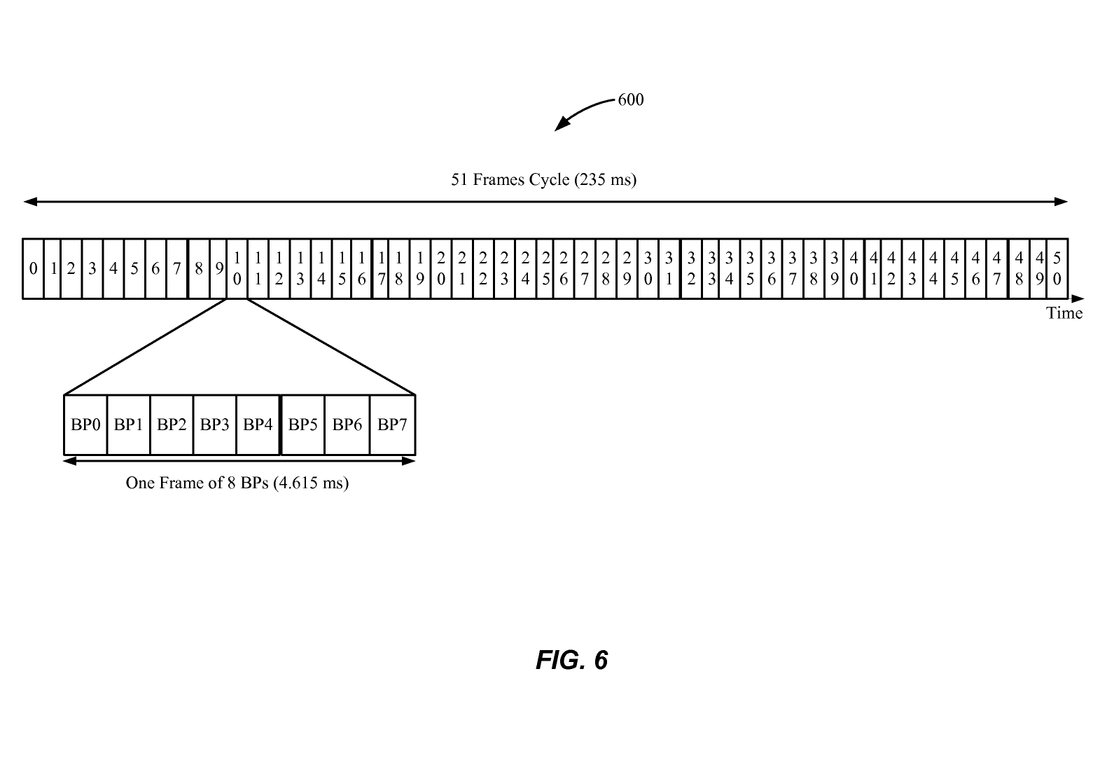

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

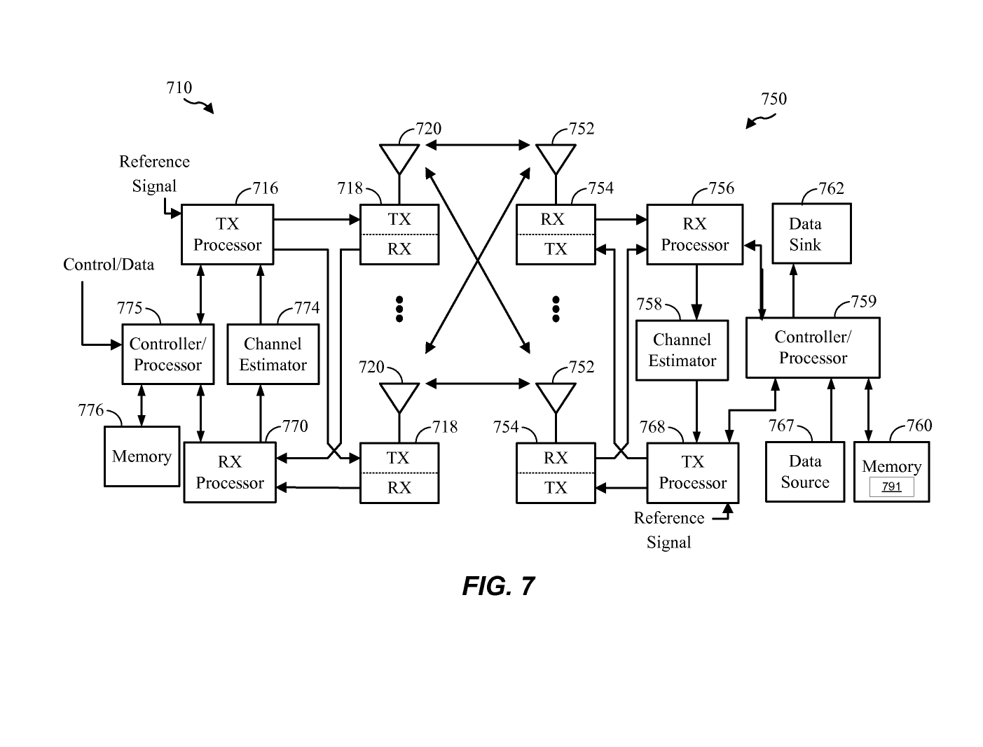

FIG. 7 is a block diagram of a base station (e.g., eNodeB or nodeB) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates a radio frequency (RF) carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor can be associated with a memory 760 that stores program codes and data. The memory 760 may be referred to as a computer-readable medium. In the uplink, the control/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controllers/processors 775 and 759 can be associated with memories 776 and 760, respectively, that store program codes and data. For example, the controller/processors 775 and 759 may provide various functions including timing, peripheral interfaces, voltage regulation, power management, and other control functions. The memories 776 and 760 may be referred to as a computer-readable media. For example, the memory 760 of the UE 750 may store a channel state module 791 which, when executed by the controller/processor 790, configures the UE 750 to determine a tune away period for one or more receive chains and to report channel state to a network according to aspects of the present disclosure.

In the uplink, the control/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

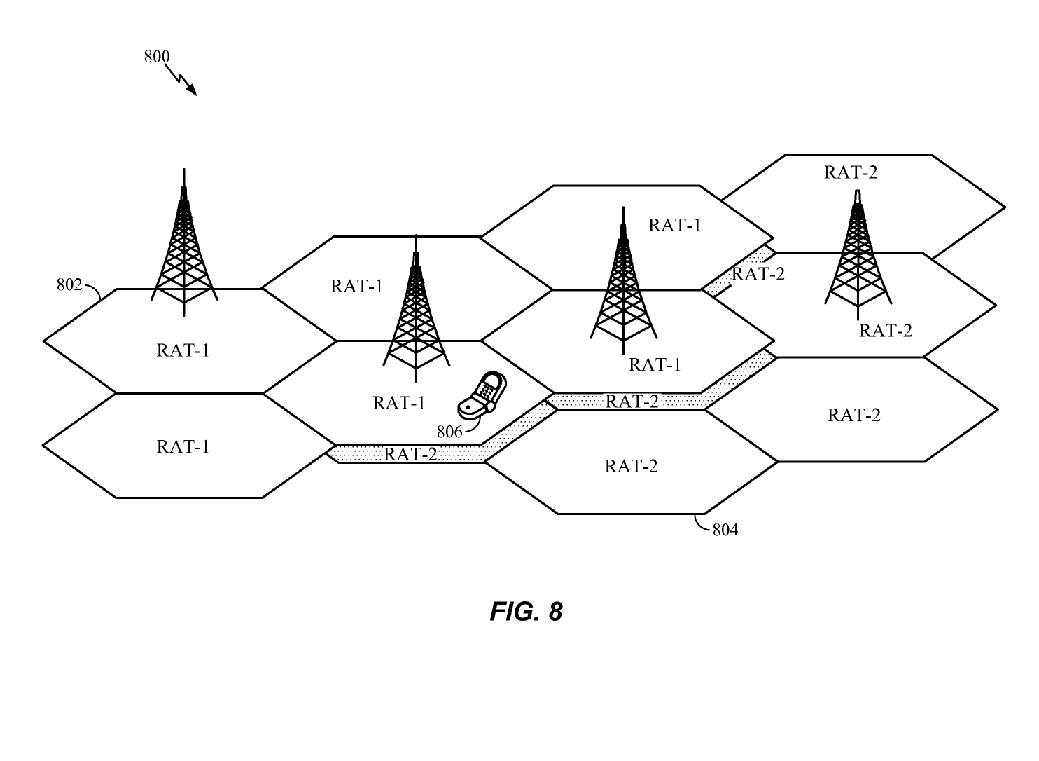

Some networks may be deployed with multiple radio access technologies. FIG. 8 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 800 includes RAT-1 cells 802 and RAT-2 cells 804. In one example, the RAT-1 cells are 2G or 3G cells and the RAT-2 cells are LTE cells. However, those skilled in the art will appreciate that other types of radio access technologies may be utilized within the cells. A user equipment (UE) 806 may move from one cell, such as a RAT-1 cell 802, to another cell, such as a RAT-2 cell 804. The movement of the UE 806 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using multiple radio frequency (RF) chains to transmit and receive communications. In one example, a multi-SIM device includes a first SIM dedicated to operate in a first RAT and a second SIM dedicated to operate in a second RAT. In one illustrative example, the multi-SIM device includes a first SIM configured to operate in a fourth generation (4G) radio access technology (RAT) (e.g., LTE) and a second SIM configured to operate in a second/third generation (2G/3G) RAT. The multi-SIM device may also operate in other RATs known to those skilled in the art.

When a fourth generation radio access technology subscription is in a radio resource control (RRC) connected mode without voice traffic, the dual subscriber identity module dual standby UE supports tuning away. For example, the UE tunes away from the fourth generation RAT to the second/third generation RAT with the least amount of interruption to the fourth generation connected mode operation. That is, the UE periodically tunes away from the fourth generation RAT to perform one or more communication activities for the second/third generation (2G/3G) RAT. The communication activities may include monitoring for a page on the second/third generation RAT, collecting broadcast control channel (BCCH) system information blocks (SIBs), performing cell reselection, etc. If a page is detected when the UE is tuned to the second/third generation RAT, the multi-subscriber identity module multi-standby UE suspends all operations of the fourth generation RAT and transitions to the second/third generation RAT. When a page is not detected on the second/third generation RAT, the UE tunes back or attempts to tune back to the fourth generation RAT and attempts to recover the original operation of the fourth generation RAT.

When a UE tunes one receiver of a radio frequency receive chain away, a base station (e.g., LTE eNodeB) schedules a physical downlink shared channel (PDSCH) for downlink (DL) data based on channel state information reported via the receiver before tuning away. The channel state information may include a channel quality indicator (CQI), pre-coding matrix indicator (PMI) and rank indicator (RI). The unavailability of the receiver during tune away may cause UE decoding failure and LTE throughput loss when the PDSCH for downlink data is scheduled on the receiver. For example, the CSI may indicate that two transport blocks should be sent. If the UE tuned the receiver away, then neither transport block can be received by the receiver.

### Channel State Reporting During Tune Away in Multi-Subscriber Identity Module Device

Aspects of the present disclosure are directed to reducing decoding failure and throughput loss when a user equipment (UE) tunes away from a first radio access technology (RAT) to a second radio access technology. A UE may be scheduled to periodically tune away to perform communication activities for the second RAT. For example, the decoding failure and throughput loss (e.g., long term evolution (LTE) throughput loss) may occur when a communication channel (e.g., physical downlink shared channel (PDSCH)) for downlink data is scheduled on an unavailable tune away receiver of a radio frequency receive chain.

In one aspect of the present disclosure, the UE with multiple radio frequency receive chains and multiple subscriber identity modules (SIMs) determines or predicts when one or more radio frequency receive chains will tune away from a first SIM to one or more SIMs of the multiple SIMs. In one aspect of the disclosure, the UE may determine or identify an exact time to monitor for a page on the second SIM. For example, a UE with four receive chains (e.g., receive chains A, B, C and D) may determine or predict when receive chains A and B will tune away from a first SIM of a first RAT (e.g., LTE) to a second SIM of a second RAT (e.g., second/third generation RAT). In one aspect of the disclosure, the user equipment is a multi-SIM multi-standby device.

The UE reports a communication channel state to a network based on measurements obtained without one or more receive chains (e.g., receive chains A and B) that are predicted to tune away. In one aspect of the disclosure, the measurement and/or reporting of the communication channel state occur during a predetermined time period before the predicted tune away. For example, the communication channel state that is reported may be based on measurements obtained with the receive chains C and D that are not predicted to tune away. The communication channel state may be reported with the receive chains C and/or D, which are not tuned away. The UE also reports the communication channel state based on measurements obtained without the one or more receive chains (e.g., receive A and/or B) during the predicted tune away. The measurements may also be obtained without the receive chains A and B during the predicted tune away. Thus, only channel states based on measurements obtained by the received chains that are not tuned away or predicted to tune away are reported during the predicted tune away and during the time period before the predicted tune away.

After the receive chain(s) returns from the predicted tune away, the UE may resume reporting channel state based on measurements obtained with the returned receive chain(s). For example, the UE may obtain measurements with the returned receive chains A and B and report the channel states after the tune away period. In some aspects, the UE periodically reports the channel state based on measurements obtained with the receive chains A and B up until a predetermined time period before the predicted tune away. The predetermined time period can be based on channel conditions, serving cell signal quality, calculated length of time of the tune away, and/or an application/procedure running on the first SIM. For example, if the serving cell signal quality is good (e.g., above a threshold), the predetermined time period may be longer. If, however, the predicted or calculated length of time of the tune away is short, the predetermined time period may be longer.

Consequently, the UE may receive a resource allocation based on a number of receive chains performing measurements for the channel state reporting. For example, the reported channel state, such as channel quality indicator (CQI), pre-coding matrix indicator (PMI) and rank indicator (RI), may indicate the appropriate number and size of transport blocks the UE will be able to decode without the tuned away receiver(s).

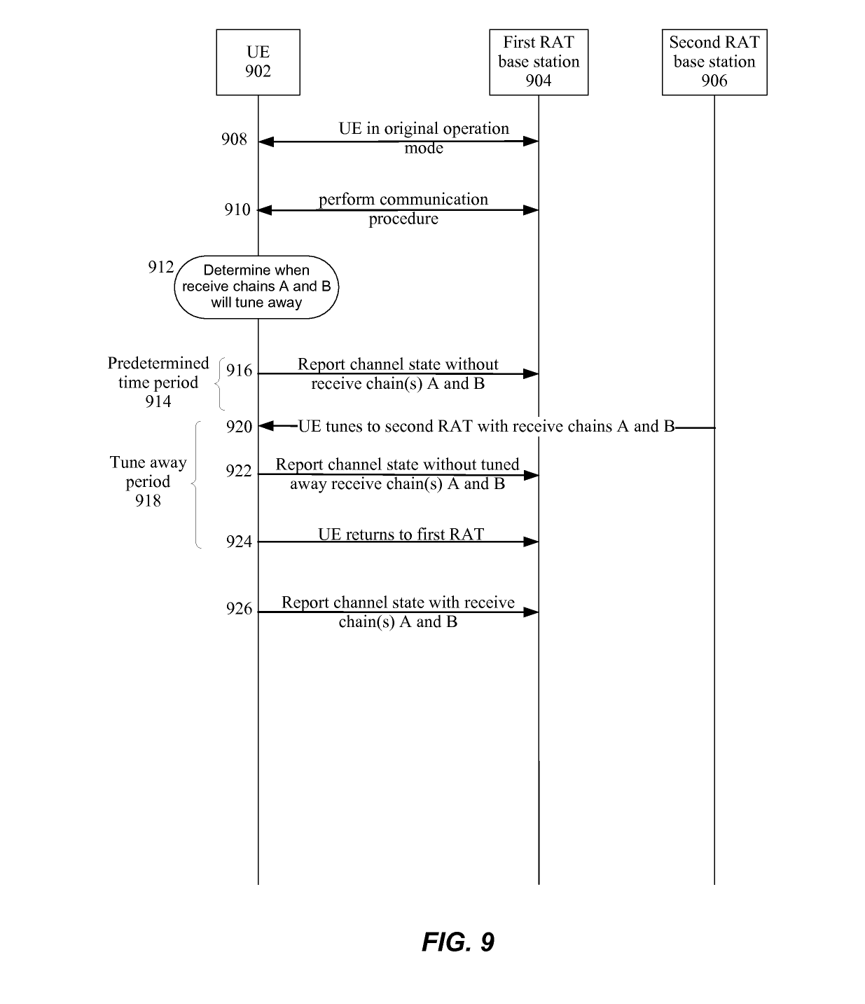

FIG. 9 illustrates an example of a call flow diagram for a tune away method for a user equipment (UE) with multiple radio frequency receive chains and multiple subscriber identity modules (SIMs) in a wireless network according to aspects of the present disclosure.

At time 908, a user equipment (UE) 902 is in an original operation mode, such as a connected mode or a dedicated channel (DCH) mode with a network of a first RAT (e.g., LTE). At time 910, the UE performs communication procedures corresponding to the original operation mode, such as a random access procedure, a handover procedure, hybrid automatic repeat request (HARQ) transmission, etc. For example, the UE 902 communicates with a base station 904 of the first RAT in response to a page for a call on the first RAT of the UE 902. At time 912, the UE 902 independently predicts when one or more radio frequency receive chains (e.g., receivers A and B) will tune away from a first SIM to one or more SIMs of the multiple SIMs.

The UE 902 reports a communication channel state to a network based on measurements obtained without the one or more receive chains A and B that are predicted to tune away. For example, the UE 902 independently defines a predetermined time period 914, which occurs before the tune away with the receive chains A and B. The UE 902 reports channel state at time 916 without the receive chains A and B during the predetermined time period 914. In some aspects, the measurements upon which the channel state is based are also obtained during the predetermined time period.

At time 920, the UE 902 tunes away to perform activities on a second RAT with the receive chains A and B. For example, the UE 902 tunes to a base station 906 of the second RAT with the receive chains A and B to obtain measurements on the second RAT. The UE 902 may be tuned to the base station 906 for a tune away period 918. At time 922, while the UE 902 is tuned away to the second RAT, the UE 902 reports the communication channel state based on measurements obtained without the one or more receive chains A and B. The measurements on which the channel state is based may also be obtained during the tune away period 918. At time 924, the UE 902 returns to the base station 904 of the first RAT after the tune away period 918. At time 926, the UE 902 reports a communication channel state to the network with the one or more receive chains A and B, after the one or more receive chains returns from the tune away.

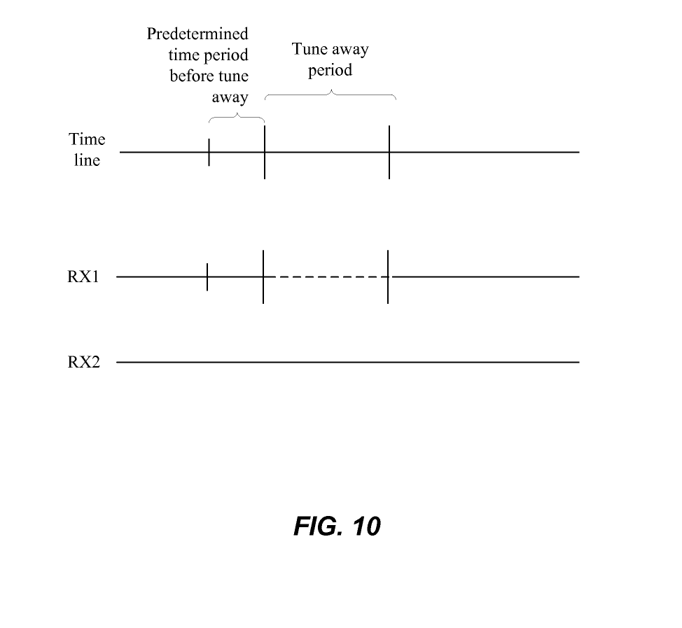

FIG. 10 illustrates a communication resource allocation time line for tuning away with one or more receive chains according to aspects of the present disclosure. FIG. 10 includes the communication time line, corresponding illustrations of a first receive chain RX1, and a second receive chain RX2. The UE reports a communication channel state to a network with the receive chain RX1 or the receive chain RX2. The communication channel state is based on measurements obtained with the receive chains RX1 or RX2.

In one aspect, the UE may predict a tune away period with the receive chain RX1. The UE may independently define a predetermined time period before the tune away when the UE stops performing measurements with the received chain RX1 and/or report the channel state with the received chain RX1. During the predetermined time period, the UE performs measurements with the receive chain RX2 and reports the channel state based on the measurements with the receive chain RX2. Similarly, during the tune away period, the UE performs measurements with the receive chain RX2 and reports the channel state based on the measurements with the receive chain RX2. After the tune away period, the UE resumes measurements and channel state reporting with the receive chain RX1.

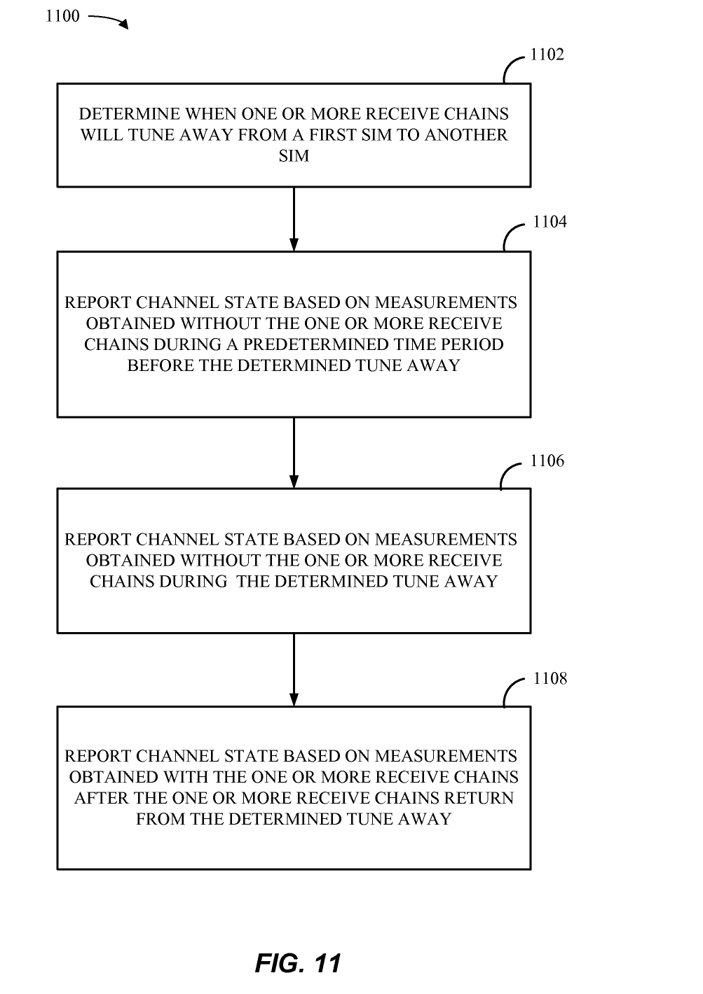

FIG. 11 shows a wireless communication method 1100 according to one aspect of the disclosure. A user equipment (UE) with multiple receive chains and multiple subscriber identity modules (SIMs) determines when one or more receive chains will tune away from a first SIM to another SIM, as shown in block 1102. The UE reports a channel state based on measurements obtained without the one or more receive chains during a predetermined time period before the determined tune away, as shown in block 1104. The UE also reports the channel state based on measurements obtained without the one or more receive chains during the determined tune away, as shown in block 1106. The UE reports the channel state based on measurements obtained with the one or more receive chains after the one or more receive chains return from the determined tune away, as shown in block 1108.

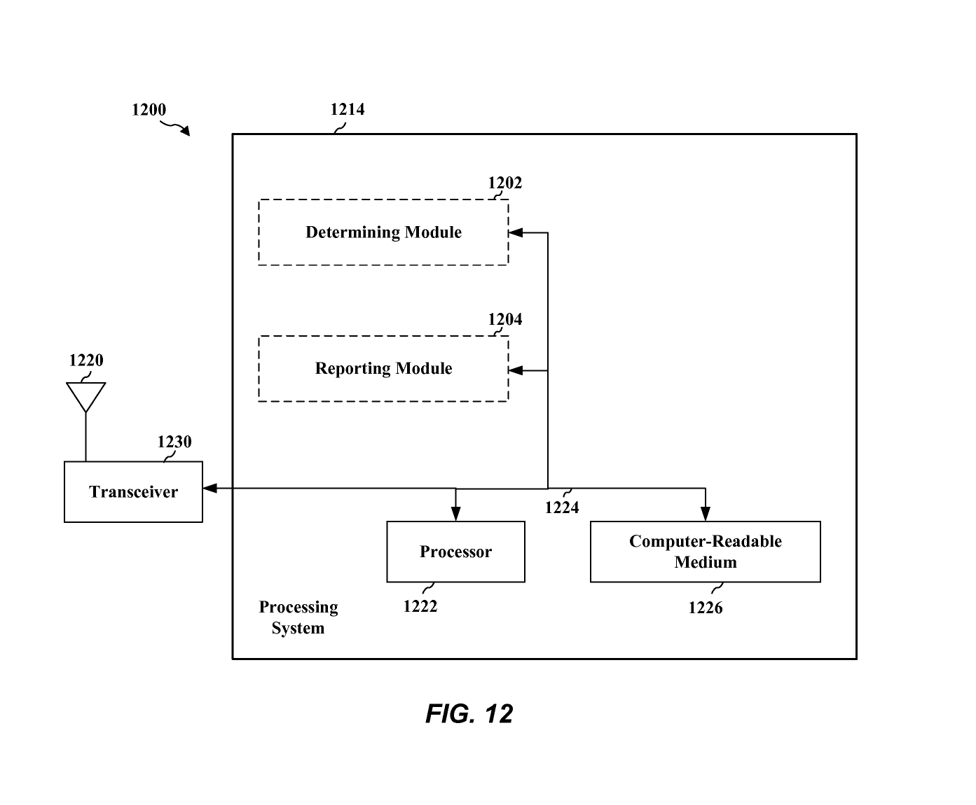

FIG. 12 is a diagram illustrating an example of a hardware implementation for an apparatus 1200 employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, the modules 1202, 1204 and the non-transitory computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatuses over a transmission medium. The processing system 1214 includes a processor 1222 coupled to a non-transitory computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a determining module 1202 for determining when one or more receive chains will tune away from a first subscriber identity module (SIM) to another SIM. The processing system 1214 includes a reporting module 1204 for reporting channel state to a network. The modules may be software modules running in the processor 1222, resident/stored in the computer-readable medium 1226, one or more hardware modules coupled to the processor 1222, or some combination thereof. The processing system 1214 may be a component of the UE 750 and may include the memory 760, and/or the controller/processor 759.

In one configuration, an apparatus such as a UE is configured for wireless communication including means for determining. In one aspect, the determining means may be the receive processor 756, the controller/processor 759, the memory 760, the channel state module 791, the determining module 1202, and/or the processing system 1214 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE is configured for wireless communication including means for reporting. In one aspect, the reporting means may be the antennas 752/1220, the transmitter 754, the transceiver 1230, the transmit processor 768, the controller/processor 759, the memory 760, the channel state module 791, the reporting module 1204, and/or the processing system 1214 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE, TD-SCDMA, 5G (fifth generation) and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for a user equipment (UE) with multiple receive chains and multiple subscriber identity modules (SIMs), comprising:
determining when at least one receive chain will tune away from a first SIM to another SIM;
reporting a channel state based at least in part on measurements obtained without the at least one receive chain during a predetermined time period before the determined tune away;
reporting the channel state based at least in part on measurements obtained without the at least one receive chain during the determined tune away; and
reporting the channel state based at least in part on measurements obtained with the at least one receive chain after the at least one receive chain returns from the determined tune away.

2. The method of claim 1, further comprising receiving a resource allocation based at least in part on a number of receive chains performing measurements for the reported channel state.

3. The method of claim 1, further comprising periodically reporting channel state based on measurements obtained with the at least one receive chain up until the predetermined time period before the determined tune away.

4. The method of claim 1, in which the predetermined time period is based at least in part on channel conditions, serving cell signal quality, calculated duration of tune away, and/or application and procedure running on the first SIM.

5. The method of claim 1, in which reporting the channel state obtained without the at least one receive chain during the determined tune away comprises reporting measurements taken with at least one receive chain that is not tuned away.

6. An apparatus for wireless communication for a user equipment (UE) with multiple receive chains and multiple subscriber identity modules (SIMs), comprising:
means for determining when at least one receive chain will tune away from a first SIM to another SIM;
means for reporting a channel state based at least in part on measurements obtained without the at least one receive chain during a predetermined time period before the determined tune away;
means for reporting the channel state based at least in part on measurements obtained without the at least one receive chain during the determined tune away; and
means for reporting the channel state based at least in part on measurements obtained with the at least one receive chain after the at least one receive chain returns from the determined tune away.

7. The apparatus of claim 6, further comprising means for receiving a resource allocation based at least in part on a number of receive chains performing measurements for the reported channel state.

8. The apparatus of claim 6, further comprising means for periodically reporting channel state based on measurements obtained with the at least one receive chain up until the predetermined time period before the determined tune away.

9. The apparatus of claim 6, in which the predetermined time period is based at least in part on channel conditions, serving cell signal quality, calculated duration of tune away, and/or application and procedure running on the first SIM.

10. The apparatus of claim 6, in which the means for reporting the channel state obtained without the at least one receive chain during the determined tune away comprises means for reporting measurements taken with at least one receive chain that is not tuned away.

11. An apparatus for wireless communication for a user equipment (UE) with multiple receive chains and multiple subscriber identity modules (SIMs), comprising:
a memory; and
at least one processor coupled to the memory and configured:
to determine when at least one receive chain will tune away from a first SIM to another SIM;
to report a channel state based at least in part on measurements obtained without the at least one receive chain during a predetermined time period before the determined tune away;
to report the channel state based at least in part on measurements obtained without the at least one receive chain during the determined tune away; and
to report the channel state based at least in part on measurements obtained with the at least one receive chain after the at least one receive chain returns from the determined tune away.

12. The apparatus of claim 11, in which the at least one processor is further configured to receive a resource allocation based at least in part on a number of receive chains performing measurements for the reported channel state.

13. The apparatus of claim 11, in which the at least one processor is further configured to periodically report channel state based on measurements obtained with the at least one receive chain up until the predetermined time period before the determined tune away.

14. The apparatus of claim 11, in which the predetermined time period is based at least in part on channel conditions, serving cell signal quality, calculated duration of tune away, and/or application and procedure running on the first SIM.

15. The apparatus of claim 11, in which the at least one processor is further configured to report the channel state obtained without the at least one receive chain during the determined tune away by reporting measurements taken with at least one receive chain that is not tuned away.

16. A computer program product for wireless communication for a user equipment (UE) with multiple receive chains and multiple subscriber identity modules (SIMs), comprising:
a non-transitory computer-readable medium having program code recorded thereon, the program code comprising:
program code to determine when at least one receive chain will tune away from a first SIM to another SIM;
program code to report a channel state based at least in part on measurements obtained without the at least one receive chain during a predetermined time period before the determined tune away;
program code to report the channel state based at least in part on measurements obtained without the at least one receive chain during the determined tune away; and
program code to report the channel state based at least in part on measurements obtained with the at least one receive chain after the at least one receive chain returns from the determined tune away.

17. The computer program product of claim 16, further comprising program code to receive a resource allocation based at least in part on a number of receive chains performing measurements for the reported channel state.

18. The computer program product of claim 16, further comprising program code to periodically report channel state based on measurements obtained with the at least one receive chain up until the predetermined time period before the determined tune away.

19. The computer program product of claim 16, in which the predetermined time period is based at least in part on channel conditions, serving cell signal quality, calculated duration of tune away, and/or application and procedure running on the first SIM.

20. The computer program product of claim 16, further comprising program code to report the channel state obtained without the at least one receive chain during the determined tune away by reporting measurements taken with at least one receive chain that is not tuned away.
